(19) United States
(12) Patent Application Publication
(10) Pub. No.: US 2013/0103843 A1
(43) Pub. Date: Apr. 25, 2013

(54) METHOD FOR ESTABLISHING A COMMUNICATION LINK BETWEEN A PROGRAMMING DEVICE AND AN AUTOMATION TECHNOLOGY FIELD DEVICE

(71) Applicant: Siemens Aktiengesellschaft, Munchen (DE)

(72) Inventor: CARSTEN REBBEREH, Furth (DE)

(73) Assignee: Siemens Aktiengesellschaft, Munchen (DE)

(21) Appl. No.: 13/659,663

(22) Filed: Oct. 24, 2012

(30) Foreign Application Priority Data
Oct. 25, 2011 (EP) 11186462.5

(51) Int. Cl. G06F 15/16

(52) U.S. Cl. 709/227

(57) ABSTRACT

In a method for establishing a communication link between a programming device and an automation technology field device with an activatable DHCP server, the programming device is configured to automatically obtain a network address from a DHCP server upon connection to a field device with such activatable DHCP server or upon connection to a network with at least one field device having an activatable DHCP server.

### CROSS-REFERENCES TO RELATED APPLICATIONS

This application claims the priority of European Patent Application, Serial No. 11186462.5, filed Oct. 25, 2011, pursuant to 35 U.S.C. 119(a)-(d), the content of which is incorporated herein by reference in its entirety as if fully set forth herein.

### BACKGROUND OF THE INVENTION

The present invention relates to a method for establishing a communication link between a programming device and an automation technology field device, and more particularly to a method for the automatic configuration of links between a programming device and one or several field devices via Ethernet interfaces.

The following discussion of related art is provided to assist the reader in understanding the advantages of the invention, and is not to be construed as an admission that this related art is prior art to this invention.

The term automation technology field device refers in general to an automation device according to the following definition and especially to such an automation device which is arranged in the respective technical process, in other words for instance adjacent to controlled and/or monitored assemblies and suchlike. Furthermore, the term automation device and also the term automation technology field device includes all devices, facilities or systems, in other words in addition for instance to controllers, such as programmable controllers, process computers, (industrial) computers and suchlike, also drive controllers, frequency inverters and suchlike, such as are or can be used for instance to control, regulate and/or monitor technological processes, such as for instance forming or transporting material, energy or information etc., wherein energy is expended or converted in particular by way of suitable technical facilities, such as for instance sensors or actuators.

Such devices and programming devices which can be communicatively linked thereto are known per se. A communication link of a programming device to at least one automation technology field device is needed for instance when commissioning the respective field device, in other words for parameterization and suchlike, or to diagnose the field device.

The measures needed to activate a field device from a programming device, in other words for instance a laptop computer or suchlike, are unfavorable in this context, if the link is established via a standard Ethernet interface of the programming device. It was previously often necessary in this context for the user of the programming device to have knowledge of the network addresses or other identifiers of the automation technology field device and to be able to suitably parameterize the programming device with such data so as to accept the communication link. This requires specialist knowledge and is also prone to faults.

A manual configuration of the programming device and of the respective field device already outlined above is known, so that activation of the field device is possible. With the communication link being established as such, no activation of the respective field device or of the respective field devices is usually possible via names or similar identifiers. On the other hand, the use of a dedicated so-called DHCP server and, if activation via names is desired, the use of an additional DNS server, is also taken into consideration. A DHCP server as is generally known enables automatic incorporation of a further client into an existing network without its manual configuration, by the DHCP server assigning a suitable network configuration to the respective client. Only the automatic obtaining of a network address normally has to be set for the newly added client. When the client starts or connects, he/she can obtain all the relevant network configurations, namely in particular his/her own future network address, a network mask, a gateway etc. from the DHCP server.

The effort involved in establishing the communication link is relatively high both during the manual configuration and also during the use of a dedicated DHCP server, and the user has to identify network addresses or even define the same. The path to a successful connection setup is relatively long.

It would therefore be desirable and advantageous to obviate prior art shortcomings and to provide an improved method for establishing a communication link, without requiring the user having to concern him/herself with network addresses, interface parameters and the like.

### SUMMARY OF THE INVENTION

According to one aspect of the present invention, a method for establishing a communication link between a programming device and an automation technology field device having an activatable DHCP server includes the steps of connecting the programming device to a field device having an activatable DHCP server or to a network having at least one field device with an activatable DHCP server, and automatically obtaining with the programming device a network address from the DHCP server.

The field device, or when multiple field devices are connected, each field device includes an activatable DHCP server. The programming device is configured to automatically obtain a network address from a DHCP server. With a connection to a field device having an activatable DHCP server or to a network having at least one field device with an activatable DHCP server, the programming device obtains a network address. With this network address, the programming device can become a communication client either in a minimal communication network including only the programming device and an automation technology field device or in a communication network having at least one automation technology field device and possible further automation technology field devices or other devices.

According to an advantageous feature of the present invention, the field device, to which the communication link is to be set up, including an activatable DHCP server. A dedicated DHCP server is therefore no longer necessary and a DHCP server is always available with the activatable DHCP server included in the field device itself, even in minimal communication networks. By the programming device being configured to automatically obtain a network address from a DHCP server, the programming device, upon connection to such a field device, can obtain a network address from its activatable DHCP server, and activates the field device thereunder, as a future communication client, in order to perform parameterizations and suchlike or trigger a diagnosis.

According to another advantageous feature of the present invention, the field device may also include an activatable DNS server, allowing client names to also be identified and triggered in the form of the respectively associated network address.

With a plurality of communicatively linked field devices, the DHCP server or DHCP server and DNS server thereof may advantageously be activated only in one field device in each instance and for the DHCP servers or DHCP servers and DNS servers thereof to be deactivated in all other field devices. This ensures the clarity of the information conveyed according to the Dynamic Host Communication protocol, so that even with a plurality of communicatively linked field devices, a network address is assigned to the programming device from precisely one activated DHCP server.

According to another advantageous feature of the present invention, the assignment of a network address to the programming device takes place in the following steps: if a communication network exists at least in the form of a connection of the programming device to the field device, the field device sends a DHCP request, referred to below as a request, in particular as a broadcast, into the communication network and therefore requests a network address. Upon receipt of a response to the request, the field device assumes a network address contained in the response as its own network address and deactivates its DHCP server. In such a situation, at least one further device with a DHCP server or a comparable functionality still exists in the communication network. If the field device conversely receives no response to the request within a predetermined time span, this assigns itself a network address and activates its DHCP server. This then ensures that a constellation exists in which no further field device with an activated DHCP server or another device with a DHCP server or a comparable functionality exists in the communication network. The programming device can now obtain a network address from precisely one active DHCP server in the communication network and is then connected as an authorized client to the communication network and thus to the at least one automation technology field device.

According to another advantageous feature of the present invention, in conjunction with the activation of the DHCP server for the respective field device, its DNS server may also be activated, a unique identifier, for example a serial number or suchlike, may be entered as its own client name into a DNS list which can be used for the DNS server. In this way the automation technology field device can also be activated under the client name stored in the DNS list, by the programming device with its network address assigned thereto sending a DNS request referred to below as a request to the DNS server or the only activated DNS server, whereupon the DNS server returns the network address of the automation technology field device referred to by the respective client name.

According to another advantageous feature of the present invention, the field device with an activated DHCP server and activated DNS server in field devices added to the communication network may request a unique identifier which may then be entered as a client name of the added field device into the DNS list of its own activated DNS server. Such a request can take place for instance by way of FTP access to a predetermined or predeterminable memory location in the field device. The DNS list of the activated DNS server is in this way continuously activated if further field devices are added to the communication network, so that such added field devices can also be activated by the programming device, without interventions by the user being necessary in the programming device or communication network.

According to another advantageous feature of the present invention, a DNS server may be active in the or each field device in the communication network, whereby the DNS server of the field device with an activated DHCP server then functions as a primary DNS server and each other DNS server functions as a secondary DNS server, with each secondary DNS server in its own DNS list managing at least the client name of its “own” field device. The field device with the active DHCP server and the primary DNS server can then send the newly added field device a so-called Reverse LookUp request, similarly referred to for short below as a request, after assigning a network address to a newly added field device, and with its secondary DNS server request its client name and subsequently enter the same into its own DNS list. The DNS server provided in each field device therefore functions like the afore-cited memory location, at which alternatively an identifier which can be used as a client name can be requested. The advantage of the use of a DNS server or of a DNS protocol lies in the use of the DNS protocol always being needed if provision is made in the network to trigger client names. The support of additional protocols, such as for instance FTP, is therefore not necessary. As soon as a client name requested from a secondary DNS server is entered into the DNS list of the primary DNS server, the client name of the newly added field device can be triggered in a known manner and a request directed at the primary DNS server with this client name provides the network address of the field device referred to by the client name so that this can be activated by the programming device.

According to another advantageous feature of the present invention, in the event of a request for a client name from an added field device, suitable measures may be taken to ensure that this request is always initially responded to by the secondary DNS server of the added field device and does not reach the primary DNS server in the communication network, which server may at this point in time naturally still have no information relating to this client name.

With all previously described embodiments of the method, the method for the field device with an activated DHCP server and an activated DNS server may identify the programming device upon or with a failure of a request for an identifier in the programming device, e.g. with FTP or suchlike, or a failure of a DNS request in the programming device.

The advantage of the invention and its embodiments therefore consists in particular in the method for establishing the communication link functioning both in point-to-point connections between a programming device and an automation technology field device and also in constellations in which a number of devices are linked via so-called hubs or switches. The method determines the necessary network addresses, in other words the so-called IP addresses, and renders these known to the other clients of the method, in other words either an automation technology field device or automation technology field devices on the one hand and the programming device on the other hand. This transmission of information may also include names or other identifiers of the clients, wherein the latter is not obligatory.

According to another aspect of the invention, an automation device or automation technology field device is described here and below, which is configured to execute the method and if necessary determine and set up its embodiments and to this end includes means for implementing the method. A computer program is or may be loaded into a memory, and a processing unit in the form of or in the manner of a microprocessor may be configured to execute program instructions of the computer program and at least one DHCP server or a DHCP server and a DNS server. The computer program includes computer program instructions for executing all method steps of the method as described here and below and if necessary its embodiments, if the computer program is run by the processing unit. The invention is therefore preferably implemented in software. The invention is therefore also a computer program with program code instructions which can be executed by a computer and a storage medium having a computer program of this type and finally also an automation device or an automation technology field device, in the memory of which such a computer program is or can be loaded as means for implementing the method and its embodiments.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows an automation technology field device having a programming device connected thereto or which is or can be communicatively linked thereto,

FIG. 2 shows a schematically simplified representation of a process flow according to the present invention, when establishing a communication link between a programming device and an automation technology field device,

FIG. 3 shows a schematically simplified representation of another method flow according to the present invention, when establishing a communication link between an additional field device and an automation technology field device which is already communicatively linked to a programming device, and

FIGS. 4 and 5 show schematically simplified representations of a flow chart of an implementation of the method in the form of a computer program.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

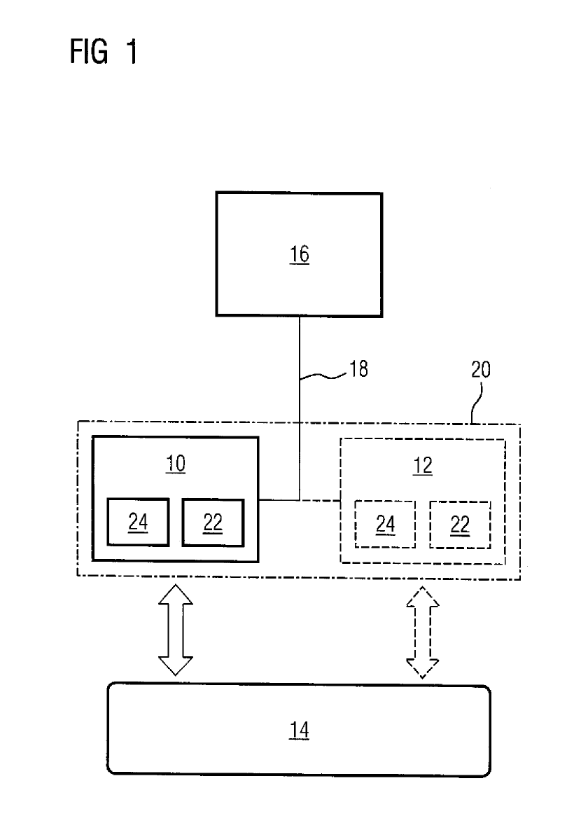

Turning now to the drawing, and in particular to FIG. 1, there is shown a schematically simplified diagram of an automation technology field device 10, which can also be summarized in general as an automation device which can be communicatively linked in a known manner to other field devices 12 or automation devices and controls and/or monitors a technical process 14 (not shown in more detail) individually or together with other field devices 12 and suchlike. A programming device 16 is provided to parameterize, diagnose etc., the or each field device 10, 12. In order to be able to respond to a field device 10, 12 of a programming device 16, e.g. a laptop computer or suchlike, a physical link 18 is required in a wired or non-wired manner between the programming device 16 and the respective field device 10 or a communication network 20, in which all devices 10-12 which are communicatively linked to one another are combined at least in an organized manner.

A transmission of data from the programming device 16 to the field device 10 and from the field device 10 to the programming device 16 is carried out by way of the physical link 18 from the programming device 16 to the or each field device 10 according to a protocol provided for the respective link 18. To this end, a communication link between the participating devices 10, 16 is also required on the basis of the respective physical link 18, and such a communication link requires at least the network address of the respective other device 10, 16 to be known to each participating device 10, 16.

In accordance with the approach proposed here, provision is made for the or each field device 10, 12 to include an activatable DHCP server 22. The programming device 16 is configured to automatically obtain a network address from a DHCP server 22. When connecting the programming device 16 to a field device 10 with an activatable DHCP server 22 or to a network 29 with at least one field device 10,12 having an activatable DHCP server 22, the programming device 16 in the DHCP server 22 obtains a network address, namely according to a method known per se and defined within the scope of the DHC protocol.

Provision can optionally be made for the field device 10 to include a DNS server 24 and for the DNS server 24 to provide the functionalities included in these services, in other words in particular the response to requests to trigger names.

With a plurality of communicatively linked field devices 10, 12, provision is made for the DHCP server 22 thereof to be activated in only one of the field devices 10 and for the DHCP server 22 thereof to be deactivated in all other field devices 12. The same applies to possible DNS servers 24 if the field devices 10, 12 include an activatable DNS server 24. Accordingly, with a plurality of communicatively linked field devices 10, 12, only in one field device 10 is its DHCP server 22 and its DNS server 24 activated and in all other field devices 12 the DHCP servers 22 and DNS servers 24 there are deactivated.

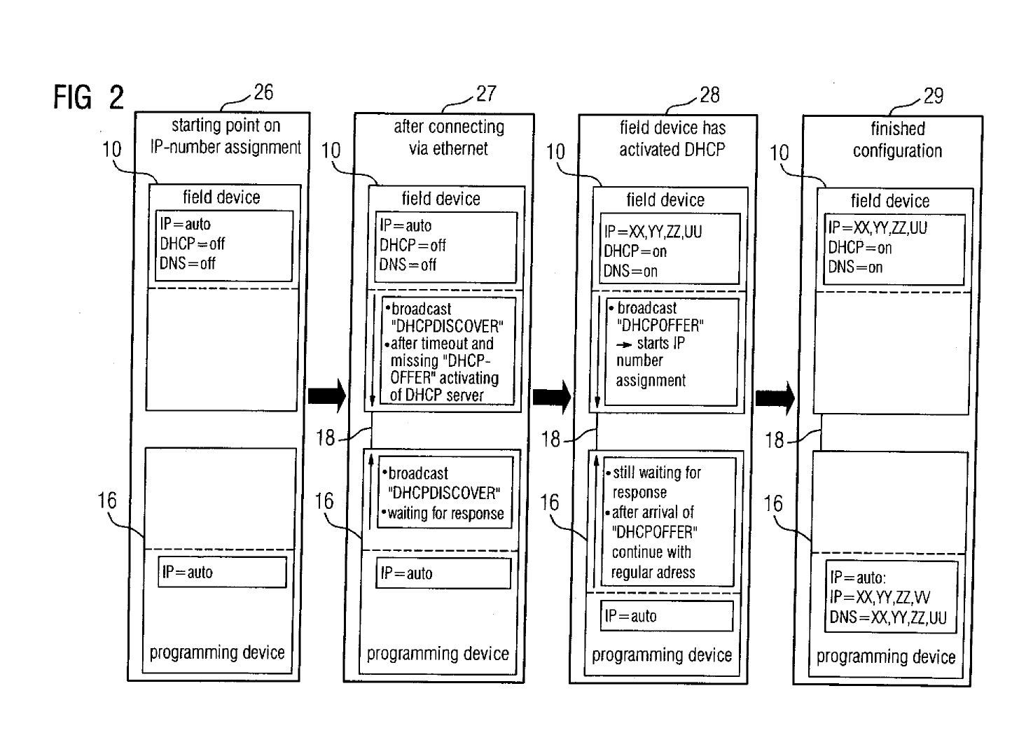

FIG. 2 now explains the method proposed here in further detail. The representation in FIG. 2 is shown again schematically simplified compared with the representation in FIG. 1 in respect of the participating devices 10, 12, 16. A first state 26, a second state 27, a third state 28 and a fourth state 29 are shown. The first state 26 represents the starting point in IP number assignment, in other words when assigning a network address. The second state 27 represents the configuration, in which the programming device 16 is connected to the field device 10 via a physical link 18, in other words in particular via Ethernet. The third state 28 represents the situation in which the field device 10 has activated its DHCP server 22 (FIG. 1). The fourth state 29 finally represents the finished configuration with the network address obtained by the programming device 16.

It is shown for the first state 26 that both the field device 10 and also the programming device 16 are configured to automatically obtain a network address (“IP=auto”). The DHCP server 22 of the field device 10 is deactivated (“DHCP=off”). A possible DNS server 24 (FIG. 1) of the field device 10 is likewise deactivated (”DNS=off”).

As soon as the programming device 16 is connected to the field device 10 (second state 27), a minimal communication network 20 exists with at least two devices/clients 10, 16. The field device 10 sends a DHCP request through its DHCP server 22 into the network 20 (DHCPDISCOVER; sent as a broadcast) and requests a network address, in other words an IP number. This is incidentally part of a method known per se for automatically obtaining network addresses for correspondingly configured clients.

If after requesting to obtain a network address within a predetermined time frame no response to the request arrives at the field device 10, the field device 10 activates its DHCP server 22 (“DHCP=on”) and assigns itself a network address, which is symbolically specified in the display as “IP=XX.YY.ZZ.UU” (third state 28). In a special embodiment of the method, failure to respond within a predetermined time span indicates that the time span has elapsed and the absence of a DHCPOFFER response to the DHCPDISCOVER request.

Similarly to the field device 10, the programming device 16 is also configured to automatically obtain a network address and sends a DHCP request (DHCPDISCOVER; sent as a broadcast) into the network 20 (second state 27), in accordance with the request for a network address. Provided the DHCP server 22 of the field device 10 is inactive, no service which can respond to the DHCP request is available in the network 20. The programming device 16 therefore initially receives no response to its request, but nevertheless waits for such a response (again second state 27; third state 28). As soon as the field device 10 has activated its DHCP server 22, this can respond to the DHCP request of the programming device 16, particularly with a DHCPOFFER response. As a result, the assignment of a network address to the programming device 16 is started according to the DHC protocol (third state 28).

A network address is finally assigned to the programming device (16) (fourth state 29), which is specified symbolically in the display as “IP=XX.YY.ZZ.VV”. The programming device 16 is therefore not only connected to the field device 10 via the connection 18, but is also communicatively connected to the field device 10, in that it is possible to exchange data using the network addresses of the field device 10 and of the programming device 16 via the connection 18 in accordance with the protocol provided for the communication connection, for instance the Internet Protocol (IP). In terms of the programming device 16, a target address is specified with the network address of the field device 10 and a source address for a transmission of data to the field device 10 is specified with its own network address. With data which the field device 10 transmits to the programming device 16, the network address of the field device 10 functions as a source address and the network address of the programming device 16 functions as a target address.

With the display in FIG. 2, in which an essentially optional DNS server 24 is assumed in the field device 10, it is indicated again for the fourth state 29 that the network address of the field device 10 was stored on the part of the programming device 16 as an address for requesting DNS services in its DNS server 24.

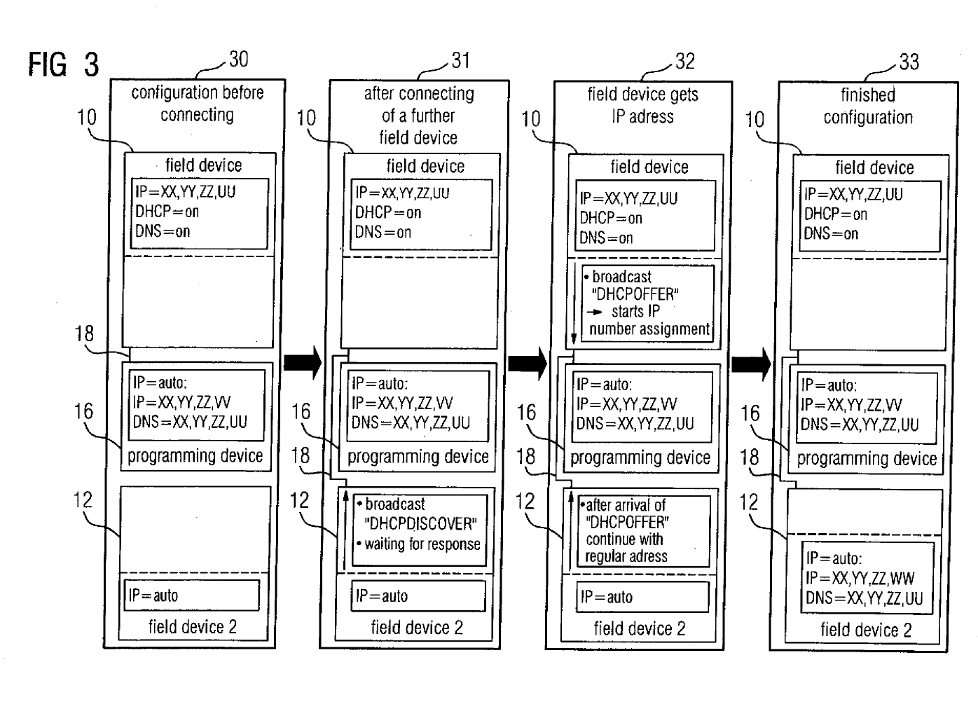

FIG. 3, similarly to FIG. 2, represents a course of a method for establishing a communication link between a further client, here a further automation technology field device 12, and an automation technology field device 10 during a first, second, third and fourth state 30-33. The feature in the situation shown in FIG. 3 consists in the communication link between a further client and at least two already communicatively linked clients taking place, namely the automation technology field device 10 and the programming device 16 connected communicatively thereto, in other words the state at the end of the method flow shown in FIG. 2.

The first state 30 is characterized in that the further automation technology field device 12 is configured for automatically obtaining a network address (“IP=auto”). For the second state 31, it is shown that the further automation technology field device 12 is connected via a suitable physical link 18 to the field device 10 or the programming device 16 or generally to the communication network 20 existing between the field device 10 and the programming device 16. On account of its configuration so as to automatically obtain a network address, the further field device 12 sends, after detecting the existing physical link 18, a DHCP request into the network 20 (DHCPDISCOVER; sent as a broadcast) and requests a network address, in other words an IP number. On account of its activated DHCP server 22 (see FIG. 2; third state 28), the field device 10 can respond to the DHCP request of the further field device 1 and responds to this with a DHCPOFFER response. The assignment of a network address to the further field device 12 is as a result started after the DHC protocol (third state 32).

Finally, a network address is assigned to the further field device 12 (fourth state 33), which is specified symbolically in the display as “IP=XX.YY.ZZ.WW”. The further field device 12 is therefore not only connected via the link 18 to the field device 10 and the programming device 16, but is also communicatively linked to the field device 10 and the programming device 16, in that it is possible to exchange data using the network addresses of the two field devices 10, 12 and of the programming device 16 via the connection 18 in accordance with the protocol provided for the communication link, for instance the Internet protocol (IP). The further field device 12 can therefore also be immediately activated by the programming device 16 for parameterization purposes and suchlike.

In the representation in FIG. 3, in which, as in the situation shown in FIG. 2, a basically optional DNS server 24 is assumed in the field device 10, it is shown again for the fourth state 33 that the network address of the field device 10 was stored as an address to request DNS services from its DNS server 24 on the part of the further field device 12.

In conjunction with the method flow shown in FIG. 3, it is important to note that the relations shown in FIG. 3 can also be reversed and a further field device 12 already connected to the network 20 may exist instead of the programming device 16 already connected to the network 20. The above description for the connection of a further field device 12 then applies accordingly for the connection of a programming device 16 to a network 20 with at least two field devices 10, 12.

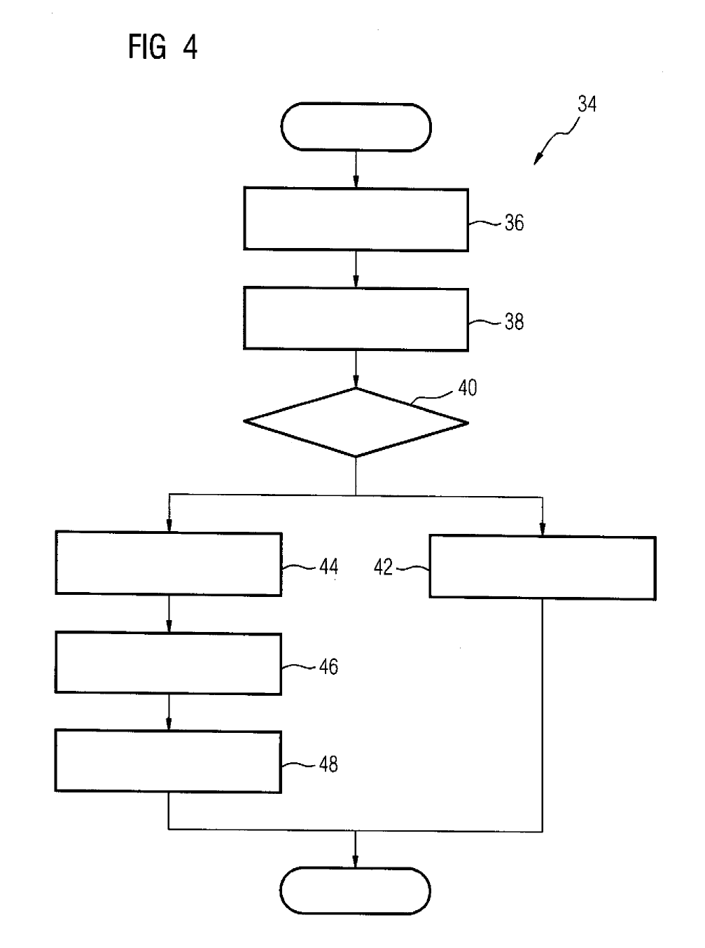

Finally FIG. 4 shows a schematically very simplified flow chart of a computer program 34, which is embodied to realize the method and if necessary its embodiments, as described here, by means of an automation technology field device 10, 12. The field device 10, 12 in a manner known per se includes a processing unit (not shown) in the manner or form of a microprocessor, and a memory (not shown), into which the computer program 34 can be loaded. During operation of the field device 10, 12, the computer program 34 is run by the processing unit. The description of the functionality of the computer program 34 is restricted to the essential aspects in conjunction with the description introduced here. Furthermore, the computer program 34 can also comprise further functions or interact with other computer programs which are likewise loaded into the memory of the field device 10, 12.

A first step 36 of the computer program 34 or computer program instructions provided for its implementation brings about a configuration of the field device 10, 12 so as to automatically obtain a network address from a DHCP server 22 and an at least initial deactivation of the own DHCP server 22 and of a possible DNS server 24. In a second step 38, the field device 10, 12 sends a DHCP request (DHCPDISCOVER) and requests a network address. A check is carried out in a third step 40 to determine whether a response to the DHCP request arrives within a predetermined or predeterminable time span (time-out). If such a response (DHCPOFFER) arrives, the computer program 34 is continued in a fourth step 42, with which, according to the DHC protocol, the assignment of a network address to the field device 10, 12 is started (the DHCP server 22 of the field device 10, 12 remains deactivated). If no such response arrives during the respective waiting time, the computer program 34 is continued in a fifth step 44. Here the field device 10, 12 assigns itself a network address and in a sixth step 46 the DHCP server 22 and if necessary a possible DNS server 24 of the field device 10, 12 is activated. A subsequent seventh step 48 is provided so that the field device 10, 12 or its now activated DHCP server 22 responds to DHCP requests from other devices and if necessary initiates the assignment of a network address (DHCPOFFER).

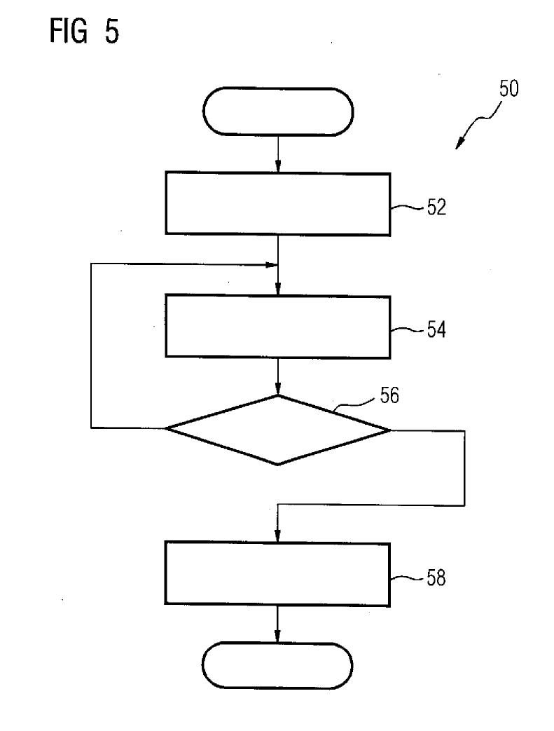

FIG. 5 shows, on the basis of the description, with the aid of the display in FIG. 4, the basic functionality of a corresponding computer program 50 for a programming device 16, which can be loaded into its memory (not shown) and can be run by its processing unit (not shown) and differs from the computer program 34 for a field device 10, 12 essentially in that the programming device 16 has no DHCP server 22 and accordingly nor can such a server be activated there.

With the computer program 50 for the programming device 16, it is also ensured in a first step 52 that the programming device 16 is configured to automatically obtain a network address from a DHCP server 22. In a second step 54, the programming device 16 sends a DHCP request (DHCPDISCOVER) and requests a network address. A check is carried out in a third step 56 to determine whether a response arrives to the DHCP request. If such a response (DHCPOFFER) arrives, the computer program 50 is continued in a fourth step 58, with which, according to the DHC protocol, the assignment of a network address to the programming device 16 is started. Provided no such response is received, the computer program 50 is continued by the continued execution of the third step 56 (if necessary of the second step 54 and of the third step 56), in order to wait for the availability of a DHCP server 22 and its response.

Individual prominent aspects of the description filed here can be summarized in brief as follows: a method for establishing a communication link between a programming device 16 and an automation technology field device 10, 12 is specified, wherein the field device 10, 12 includes an activatable DHCP server 22, wherein the programming device 16 is configured to automatically obtain a network address from a DHCP server 22 and wherein the programming device 16, upon connection to a field device 10, 12 with an activated DHCP server 22 or to a network with at least one field device 10, 12 with an activated DHCP server 22 obtains a network address from the DHCP server 22.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A method for establishing a communication link between a programming device and an automation-technology field device having an activatable DHCP server, the method comprising the steps of:
connecting the programming device to a field device with an activatable DHCP server or to a network having at least one field device with an activatable DHCP server, and
automatically obtaining from the DHCP server a network address for the programming device.

2. The method of claim 1, wherein the field device includes a DNS server.

3. The method of claim 1, wherein with a plurality of field devices interconnected for communication, a single DHCP server of only one of the plurality of field devices is activated, while the DHCP servers of all other field devices of the plurality of field devices are deactivated.

4. The method of claim 3, wherein when the communication network link between the programming device and the at least one field device is established, the method further comprising the steps of:
with at least one field device, sending a request for a network address to the communication network,
when the at least one field device receives a response to the sent request, the at least one field device assuming a network address contained in the response as own network address of the at least one field device and deactivating the DHCP server of the at least one field device,
when the at least one field device fails to receive a response to the sent request within a predetermined time span, the at least one field device assigning itself a network address and activating its DHCP server, and
obtaining a network address for the programming device from the single DHCP server active in the communication network.

5. The method of claim 2, wherein the field device activates in conjunction with activation of its DHCP server also its DNS server and enters a unique identifier as its own client name into a DNS list of its DNS server.

6. The method of claim 4, wherein the at least one field device includes a DNS server, and wherein the at least one field device activates in conjunction with activation of its DHCP server also its DNS server and enters a unique identifier as its own client name into a DNS list of its DNS server.

7. The method of claim 5, wherein the field device with the activated DHCP server and activated DNS server queries a unique identifier from a field device added to the communication network and enters this unique identifier into the DNS list as a client name of the added field device.

8. The method of claim 6, wherein the at least one field device with the activated DHCP server and activated DNS server queries a unique identifier from a field device added to the communication network and enters this unique identifier into the DNS list as a client name of the added field device.

9. The method of claim 2, wherein a DNS server is active in the field device or in each field device in the communication network, wherein the DNS server of the field device with the activated DHCP server functions as a primary DNS server and every other DNS server functions as a secondary DNS server, wherein each secondary DNS server manages at least the client name of the respective field device in its own DNS list, wherein the field device with the active DHCP server and with the primary DNS server sends a query to an added field device after a network address is assigned to the added field device and queries the client name of the added field device at the secondary DNS server of the added field device, and enters the client name of the added field device into its own DNS list.

10. The method of claim 9, wherein when the added field device is queried for a client name, the query is initially always answered by the secondary DNS server of the added field device.

11. The method of claim 5, wherein the field device with the activated DHCP server and activated DNS server identifies the programming device based on an unsuccessful query for an identifier of the programming device.

12. An automation technology field device, comprising:
a memory, into which a computer program with computer program instructions is loaded,
a processing unit for executing the computer program instructions, and
at least one activatable DHCP server and at least one DNS server,
wherein the computer program instructions, when executed on the processing unit, causes the processing unit to
connect a programming device to a field device having the activatable DHCP server or to a network having at least one field device with an activatable DHCP server, and
automatically obtain from the activatable DHCP server a network address for the programming device.
